(19) United States
(12) Patent Application Publication
(10) Pub. No.: US 2024/0359752 A1
(43) Pub. Date: Oct. 31, 2024

(54) VEHICLE CONTROL SYSTEM

(71) Applicant: Honda Motor Co., Ltd., Tokyo (JP)

(72) Inventors: Yasuyuki ONISHI, Saitama (JP); Yasutaka MASUMITSU, Saitama (JP); Jun SAWADA, Saitama (JP); Yoji SUWA, Saitama (JP); Takumi IKAWA, Saitama (JP); Yuya Sugawara, Yokohama City (JP)

(73) Assignee: Honda Motor Co., Ltd., Tokyo (JP)

(21) Appl. No.: 18/590,959

(22) Filed: Feb. 29, 2024

(30) Foreign Application Priority Data
Apr. 25, 2023 (CN) 202310450792.1

(51) Int. Cl. B62D 35/00; B60R 19/48; B62D 37/02

(52) U.S. Cl. CPC B62D 35/007; B60R 19/48; B62D 37/02

(57) ABSTRACT

A vehicle control system capable of improving aerodynamic performance of a vehicle is provided. The vehicle control system includes: a diffuser device installed on a rear bumper of a vehicle and configured to be movable between a storing position stored in the rear bumper and an extending position protruding from the rear bumper toward the rear of the vehicle; a natural wind detecting device installed on the vehicle to detect a direction of the natural wind relative to the vehicle; and a control device arranged on the vehicle and controlling movement of the diffuser device in response to the direction of the natural wind.

### CROSS-REFERENCE TO RELATED APPLICATION

This application claims the priority benefit of China application no. 202310450792.1, filed on Apr. 25, 2023. The entirety of the above-mentioned patent application is hereby incorporated by reference herein and made a part of this specification.

### BACKGROUND

### Technical Field

The disclosure relates to a vehicle control system.

### Description of Related Art

In recent years, in order to ensure more people can have access to affordable, reliable, sustainable, and advanced energy, research and development to improve fuel efficiency, which contributes to energy efficiency, have been carried out. However, in this technology related to improving fuel efficiency, the aerodynamic performance of the vehicle is an issue.

In the related art (US Patent Publication No. 2015/0166130), a diffuser device is generally arranged at the rear end (e.g., the rear bumper) of the vehicle body of a vehicle to improve the aerodynamic performance of the vehicle. A common diffuser device may be a fixed diffuser with a specific shape, but movable diffuser devices are also available. The movable part of a movable diffuser device can move in the front-rear direction of the vehicle relative to the fixed part to change its position, and the aerodynamic performance of the vehicle is adjusted in this way. However, in order to further improve the aerodynamic performance of the vehicle, it is necessary to consider the direction of the natural wind flowing through the vehicle when the vehicle is traveling, so that the aerodynamic performance of the vehicle can be improved more accurately.

In order to solve the abovementioned problems, the disclosure aims to improve the aerodynamic performance of a vehicle, thereby contributing to energy efficiency.

### SUMMARY

The disclosure provides a vehicle control system capable of improving aerodynamic performance of a vehicle.

The disclosure provides a vehicle control system including a diffuser device, a natural wind detecting device, and a control device. The diffuser device is installed on a rear bumper of a vehicle and is configured to be movable between a storing position stored in the rear bumper and an extending position protruding from the rear bumper toward the rear of the vehicle. The natural wind detecting device is installed on the vehicle to detect a direction of the natural wind relative to the vehicle. The control device is arranged on the vehicle and controls movement of the diffuser device in response to the direction of the natural wind.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is schematic top view of a vehicle in which a vehicle control system is applied according to an embodiment of the disclosure.

FIG. 2 is a schematic diagram of an electrical structure of the vehicle control system shown in FIG. 1.

FIG. 3 is a schematic view of a diffuser device used in the vehicle control system shown in FIG. 1.

FIG. 4A and FIG. 4B are schematic views of the diffuser device used in the vehicle control system shown in FIG. 1 respectively in a storing position and in an extending position.

FIG. 5 is a schematic diagram of an operation performed by the vehicle control system shown in FIG. 1 to detecting an angle based on a direction of the natural wind.

FIG. 6 is a schematic flow chart of an operation performed by the vehicle control system shown in FIG. 1 to control the diffuser device in response to the direction of the natural wind.

FIG. 7 is a curve chart in which the vehicle control system shown in FIG. 1 obtains an air resistance value of the vehicle relative to the direction of the natural wind through simulation or experiments to obtain a predetermined angle.

### DESCRIPTION OF THE EMBODIMENTS

The disclosure provides a vehicle control system including a diffuser device, a natural wind detecting device, and a control device. The diffuser device is installed on a rear bumper of a vehicle and is configured to be movable between a storing position stored in the rear bumper and an extending position protruding from the rear bumper toward the rear of the vehicle. The natural wind detecting device is installed on the vehicle to detect a direction of the natural wind relative to the vehicle. The control device is arranged on the vehicle and controls movement of the diffuser device in response to the direction of the natural wind.

In an embodiment of the disclosure, the natural wind detecting device detects an angle of the direction of the natural wind relative to a straight direction of the vehicle.

In an embodiment of the disclosure, the natural wind detecting device detects a pressure value of the natural wind, and the angle of the direction of the natural wind relative to the straight direction of the vehicle is calculated by calculating the pressure value.

In an embodiment of the disclosure, when the angle of the direction of the natural wind relative to the straight direction of the vehicle is less than a predetermined angle, the control device controls the diffuser device to move to the extending position. When the angle of the direction of the natural wind relative to the straight direction of the vehicle is greater than the predetermined angle, the control device controls the diffuser device to move to the storing position.

To sum up, in the vehicle control system provided by the disclosure, the diffuser device is configured to be movable between the storing position stored in the rear bumper and the extending position protruding from the rear bumper toward the rear of the vehicle. The natural wind detecting device detects the direction of the natural wind relative to the vehicle. The control device controls the movement of the diffuser device in response to the direction of the natural wind. In this way, the diffuser device can move to the storing position or the extending position according to the direction of the natural wind, so that the airflow guided by the diffuser device can be more accurately adjusted according to the actual situation. Accordingly, the vehicle control system provided by the disclosure can improve the aerodynamic performance.

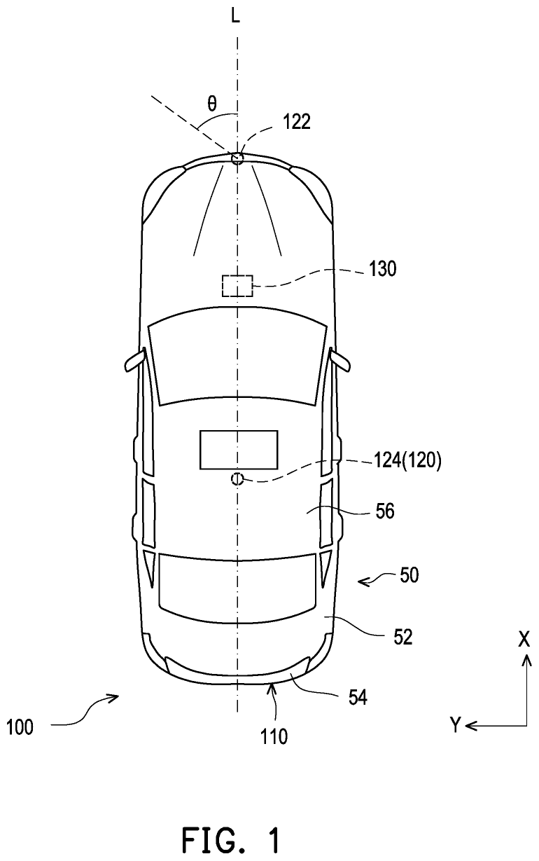

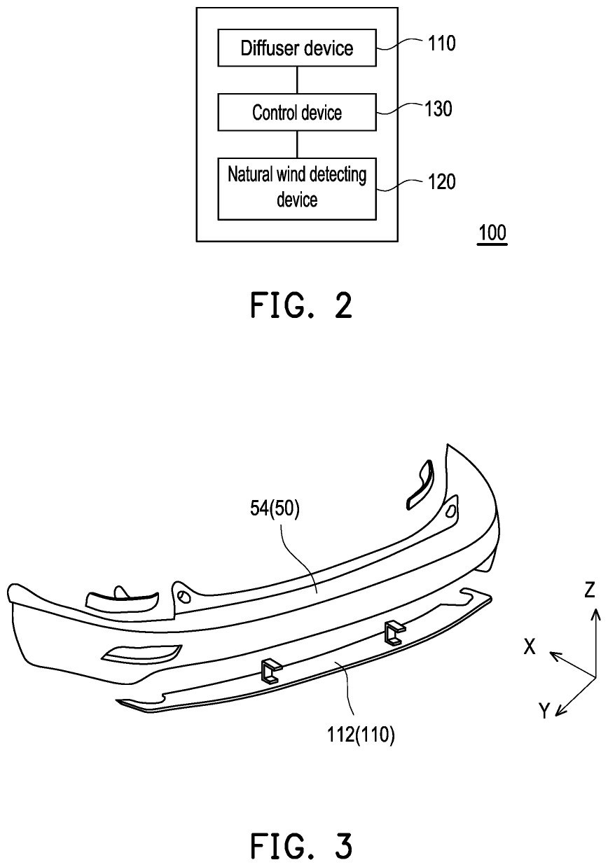

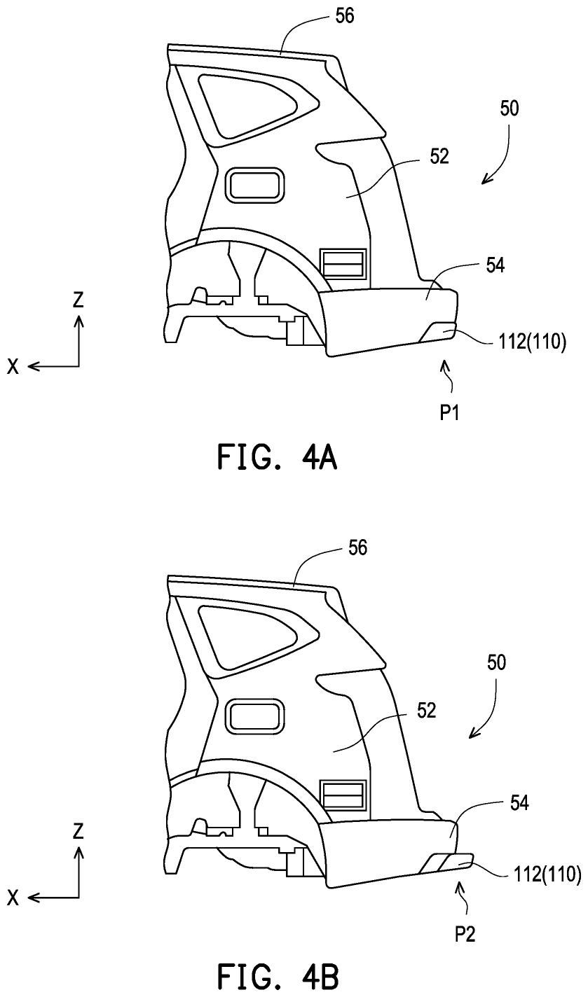

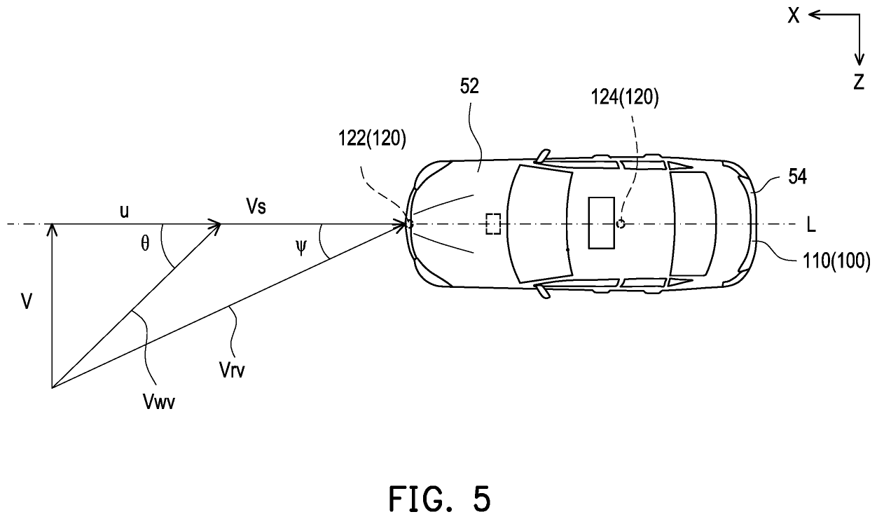

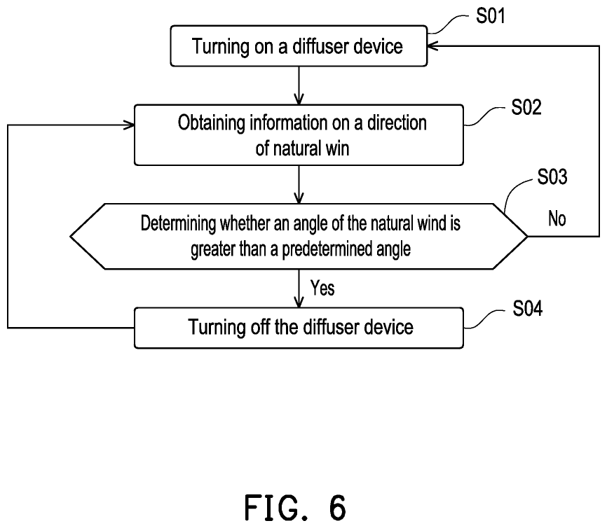

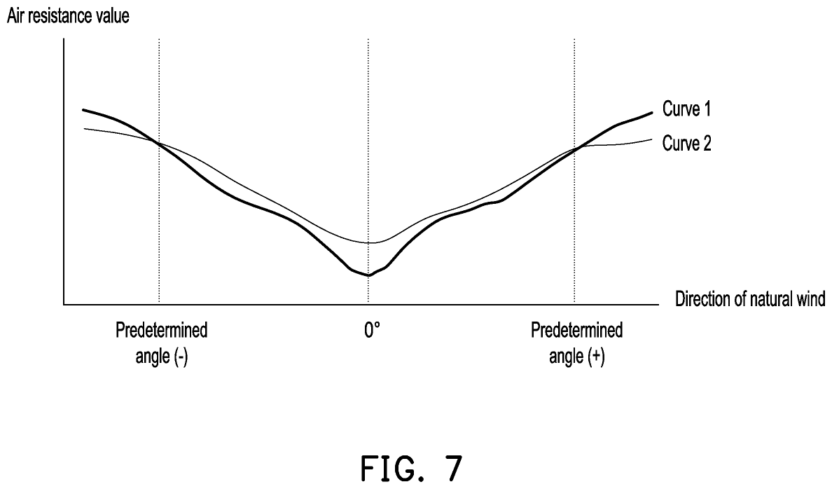

Descriptions of the disclosure are given with reference to the exemplary embodiments illustrated by the accompanying drawings. Herein, FIG. 1 is schematic top view of a vehicle in which a vehicle control system is applied according to an embodiment of the disclosure. FIG. 2 is a schematic diagram of an electrical structure of the vehicle control system shown in FIG. 1. FIG. 3 is a schematic view of a diffuser device used in the vehicle control system shown in FIG. 1. FIG. 4A and FIG. 4B are schematic views of the diffuser device used in the vehicle control system shown in FIG. 1 respectively in a storing position and in an extending position. FIG. 5 is a schematic diagram of an operation performed by the vehicle control system shown in FIG. 1 to detecting an angle based on a direction of the natural wind. FIG. 6 is a schematic flow chart of an operation performed by the vehicle control system shown in FIG. 1 to control the diffuser device in response to the direction of the natural wind. FIG. 7 is a curve chart in which the vehicle control system shown in FIG. 1 obtains an air resistance value of the vehicle relative to the direction of the natural wind through simulation or experiments to obtain a predetermined angle. The applications and the specific structure of a vehicle control system 100 provided by the present embodiment are described in the following paragraphs together with FIG. 1 to FIG. 7. Herein, in the following paragraphs, a front-rear direction of a vehicle refers to, for example, the front-rear direction X in the drawings, and the direction pointed by the arrow is the front direction. A left-right direction of the vehicle refers to, for example, the left-right direction Y in the drawings, and the direction pointed by the arrow is the left direction. Further, an up-down direction of the vehicle refers to, for example, the up-down direction Z in the drawings, and the direction pointed by the arrow is the upward direction. However, this is only one example of the disclosure, and the disclosure is not limited thereto.

With reference to FIG. 1 to FIG. 3, in this embodiment, the vehicle control system 100 includes a diffuser device 110, a natural wind detecting device 120, and a control device 130. The diffuser device 110 is suitable as an exterior device and is installed on a vehicle body 52 of a vehicle 50 to stabilize the airflow flowing through the vehicle 50, and that aerodynamic performance of the vehicle 50 is improved in this way. Herein, the diffuser device 110 is installed on a rear bumper 54 arranged on a rear end of the vehicle body 52 of the vehicle 50, and the diffuser device 110 is configured to be movable between a storing position P1 stored in the rear bumper 54 and an extending position P2 protruding from the rear bumper 54 toward the rear (i.e., a direction opposite to the direction pointed by the arrow of the front-rear direction X) of the vehicle 50 (as shown in FIG. 4A and FIG. 4B). Further, as shown in FIG. 1, the natural wind detecting device 120 is installed on the vehicle 50 to detect a direction of the natural wind relative to the vehicle 50. The control device 130 is arranged on the vehicle 50 and controls movement of the diffuser device 110 in response to the direction of the natural wind. However, the application of the vehicle control system 100 in the vehicle 50 is not limited in the disclosure and may be adjusted according to needs.

To be specific, in this embodiment, the diffuser device 110 includes, for example, a long and narrow diffuser body 112 (formed by a single plate member or a combination of multiple plate members, for example) extending in the left-right direction Y (as shown in FIG. 3) of the vehicle 50 and crossing both left and right sides of the vehicle 50 and a movable mechanism (e.g., a linkage mechanism, a sliding mechanism, etc.) that is not shown and is electrically connected to the control device 130, so as to be movable between the storing position P1 and the extending position P2 through the control of the control device 130. Herein, for instance, when a vehicle speed of the vehicle 50 does not reach a predetermined speed and when the diffuser device 110 moves to the storing position P1 under the control of the control device 130, the diffuser body 112 of the diffuser device 110 is stored in the rear bumper 54 as a part of the rear bumper 54. Further, for instance, when the vehicle speed of the vehicle 50 is equal to or greater than the predetermined speed and when the diffuser device 110 moves to the extending position P2 under the control of the control device 130, the diffuser body 112 of the diffuser device 110 is driven by the movable mechanism to protrude from the rear bumper 54 toward the rear of the vehicle 50, thereby changing the airflow around the diffuser device 110. Herein, the diffuser device 110 refers to a rear diffuser device arranged on the rear bumper 54 arranged on the vehicle body 52 of the vehicle 50. However, a specific structure of the diffuser device 110 is not limited in the disclosure and may be adjusted according to needs. For instance, the control device 130 is configured to electrically drive the movable mechanism to move the diffuser body 112, but it is not limited thereto. A mechanism for absorbing the traveling wind or natural wind of the vehicle 50 may also be arranged, and the diffuser body 112 may be moved by physically driving the movable mechanism using changes in air speed.

Further, in this embodiment, as shown in FIG. 1, the natural wind detecting device 120 detecting the direction of the natural wind relative to the vehicle 50 means that the natural wind detecting device 120 detects an angle θ of the direction of the natural wind relative to a straight direction of the vehicle 50 (that is, in front of the front-rear direction X), for example. Preferably, the natural wind detecting device 120 is, for example, a sensor. Further, the natural wind detecting device 120 includes a front portion detecting device 122 arranged in the middle of a front end portion (i.e., an end portion of the front pointed by the arrow corresponding to the front-rear direction X) of the vehicle 50 and a top portion detecting device 124 arranged in the center of a top portion (e.g., a top plate 56) of the vehicle 50, so as to detect a pressure value (corresponding to the detected pressure values Pc and Pt, for example) of the natural wind relative to the vehicle 50. In this way, the natural wind detecting device 120 detects the pressure value of the natural wind, and the angle θ of the direction of the natural wind relative to the straight direction of the vehicle 50 is obtained by calculating the pressure value. For instance, the direction of the natural wind relative to the vehicle 50 is calculated based on the pressure values Pc and Pt in a detection result via a calculation component (formed by a part of the control device 130, for example) that is not shown. However, the number, installation location, and implementation manners of the natural wind detecting device 120 are not limited in the disclosure and may be adjusted according to needs.

In addition, as shown in FIG. 1 and FIG. 2, the control device 130 is a central control unit or a processing unit arranged in the vehicle 50, for example, and is electrically connected to the natural wind detecting device 120. In this way, the detection result detected by the natural wind detecting device 120 may be sent to the control device 130 as an electrical signal. Herein, if the detection result of the natural wind detecting device 120 is the direction of the natural wind relative to the vehicle 50, the control device 130 may control the movement of the diffuser device 110 in response to the detected direction of the natural wind. If the detection result of the natural wind detecting device 120 is the angle θ of the direction of the natural wind relative to the straight direction of the vehicle 50 or the pressure value of the natural wind relative to the vehicle 50, the control device 130 may then first perform calculation based on the detection result to obtain the direction of the natural wind relative to the vehicle 50 and then control the movement of the diffuser device 110 in response to the obtained direction of the natural wind. However, the implementation manners of the control device 130 are not limited in the disclosure and may be adjusted according to needs.

Further, as shown in FIG. 1 and FIG. 5, in this embodiment, the natural wind detecting device 120 detecting the direction of the natural wind relative to the vehicle 50 aims to detect whether there is crosswind in the natural wind flowing through the vehicle 50, that is, to detect whether the angle θ of the direction of the natural wind relative to the straight direction (that is, in front of the front-rear direction X) of the vehicle 50 is greater than a predetermined angle. The angle θ of the direction of the natural wind relative to the straight direction of the vehicle 50 is defined, for example, with a center extension line L of the vehicle 50 as the center, where the center extension line L extends in the front-rear direction X corresponding to the straight direction of the vehicle 50, and the right side of the center extension line L has a positive value and the left side has a negative value. Herein, when the angle θ of the direction of the natural wind relative to the straight direction of the vehicle 50 is 0 degrees, the direction of the natural wind may be treated to be parallel to the straight direction of the vehicle 50 (that is, the direction of the natural wind is parallel to the front-rear direction X). In this way, the vehicle control system 100 may detect the direction of the natural wind flowing through the vehicle 50 relative to the vehicle 50 during the traveling of the vehicle 50 via the natural wind detecting device 120, so as to control the position of the diffuser device 110 via the control device 130 during the traveling of the vehicle 50.

As an example, the steps of obtaining information on the speed and direction of the natural wind acting on the vehicle 50 based on the pressure data (e.g., the pressure values detected by the abovementioned front portion detecting device 122 and the top portion detecting device 124) detected by the natural wind detecting device 120 and a relative air speed (related to the vehicle speed of the vehicle 50) of the vehicle 50 during traveling are described in the following paragraphs.

First, as shown in FIG. 5, the wind speed of the natural wind is set to Vwv, speed components of the natural wind are set to u and v, the vehicle speed of the vehicle 50 is set to Vs, the relative air speed of the vehicle 50 during traveling is set to Vrv, and an angle that the relative air speed Vrv presents relative to the center extension line L of the vehicle 50, that is, a yaw angle, is set to ψ.

Next, through Bernoulli's theorem, formula (1) for converting a dynamic pressure value into a wind speed is established, where ρ is an air density (the air density ρ may be additionally detected, or an appropriate value may be selected according to needs), Vrv is the relative air speed (related to the vehicle speed of the vehicle 50) of the vehicle 50 during traveling, the pressure value Pc is a pressure value detected by the front portion detecting device 122 (shown in FIG. 1) arranged in the middle of the front end portion of the vehicle 50, and the pressure value Pt is a pressure value detected by the top portion detecting device 124 (shown in FIG. 1) arranged in the center of the top portion of the vehicle 50.

$$ρ \times {( Vrv )}^{2} / 2 = Pc - Pt \qquad formula ( 1 )$$

Furthermore, formula (1) is rewritten into formula (2) to obtain the relative air speed Vrv.

$$Vrv = \sqrt{2 ( Pc - Pt ) / ρ} \qquad formula ( 2 )$$

Finally, through the aforementioned relative air speed Vrv, the yaw angle ψ of the relative air speed Vrv relative to the vehicle 50, and the vehicle speed Vs of the vehicle 50, the speed components u and v of the natural wind may be obtained from formula (3).

$$u = Vwvx = Vrv cos ψ - Vs \qquad formula ( 3 )$$

$$v = Vwvy = Vrv sin ψ$$

In this way, component values of the speed components u and v of the natural wind may be obtained, and the wind speed Vwv of the natural wind acting on the vehicle 50 and the angle θ of the direction of the natural wind relative to the straight direction of the vehicle 50 (equivalent to the wind direction of the natural wind) are thus obtained.

However, the above description is only one of the processes for obtaining the wind direction of the natural wind acting on the vehicle 50 through the conditions (e.g., vehicle speed) related to the natural wind detecting device 120 and the vehicle 50 as shown in FIG. 1 and FIG. 5. In other embodiments that are not shown, the processes of obtaining the wind direction of the natural wind may be adjusted according to the type of the installed natural wind detecting device 120 and the vehicle speed of the vehicle 50 (during traveling or not), and the disclosure is not limited thereto.

Further, in this embodiment, the purpose of detecting the direction of the natural wind relative to the vehicle 50 (whether there is crosswind) is to control the movement of the diffuser device 110 in response to the direction of the natural wind. As an example, when the angle θ of the direction of the natural wind relative to the straight direction of the vehicle 50 is less than the predetermined angle, the control device 130 controls the diffuser device 110 to move to the extending position P2 (as shown in FIG. 4B). Further, when the angle θ of the direction of the natural wind relative to the straight direction of the vehicle 50 is greater than the predetermined angle, the control device 130 controls the diffuser device 110 to move to the storing position P1 (as shown in FIG. 4A). That is, when the crosswind is light (the angle θ is less than the predetermined angle), it is preferable to move the diffuser device 110 to the extending position P2 (that is, the diffuser device 110 is turned on) to improve the aerodynamic performance of the vehicle 50. Correspondingly, when the crosswind is strong (the angle θ is greater than the predetermined angle), it is preferable to move the diffuser device 110 to the storing position P1 (that is, the diffuser device 110 is turned off) to improve the aerodynamic performance of the vehicle 50. In this way, while the aerodynamic performance of the vehicle 50 is considered, the impact of the crosswind on the air resistance value is also considered. Therefore, the predetermined angle is preferably set for the purpose of preventing the phenomenon of the crosswind lowering the air resistance value from occurring. Herein, as shown in FIG. 7, it is expected to obtain the air resistance value of the vehicle 50 relative to the direction of the natural wind through simulation or experiments to obtain the predetermined angle in advance. Herein, Curve 1 refers to a state in which the diffuser device 110 moves to the extending position P2 (turned on), and Curve 2 refers to a state in which the diffuser device 110 moves to the storing position P1 (turned off), but it is not limited thereto. The predetermined angle is, for example, plus or minus 11 degrees (plus to the right and minus to the left) centered on the center extension line L of the vehicle 50, but the predetermined angle may be adjusted according to an appearance of the vehicle 50 and other conditions, and the disclosure is not limited thereto.

Preferably, in this embodiment, an operation process performed by the vehicle control system 100 to control the diffuser device 110 in response to the direction of the natural wind is as shown in FIG. 6. First, in step S01, when the vehicle speed of the vehicle 50 is equal to or greater than the predetermined speed, the diffuser device 110 is turned on. That is, the control device 130 controls the diffuser device 110 to move to the extending position P2. Next, in step S02, information on the direction of the natural wind is obtained, for example, the angle θ of the direction of the natural wind relative to the straight direction of the vehicle 50 is obtained. Next, in step S02, it is determined whether the angle θ of the natural wind is greater than the predetermined angle. If it is determined that the angle θ of the natural wind is less than the predetermined angle (No in step S03), step S01 is performed again to maintain the turning-on state of the diffuser device 110 (that is, maintain the diffuser device 110 in the extending position P2). Correspondingly, if it is determined that the angle θ of the natural wind is greater than the predetermined angle, step S04 is performed to turn off the diffuser device 110. That is, the control device 130 controls the diffuser device 110 to move to the storing position P2. After a predetermined period of time, step S02 is performed again, the information on the natural wind is obtained, and it is determined whether the angle θ of the natural wind is greater than the predetermined angle with reference to the foregoing process, so as to decide whether to turn on or turn off the diffuser device 110 until the vehicle 50 stops traveling.

In the above process, it is determined to turn on or turn off the diffuser device 110 based on the predetermined angle (that is, the diffuser device 110 is controlled to move to the extending position P2 or the storing position P1). However, in other embodiments that are not shown, the diffuser device 110 may also be controlled to move to a plurality of positions (multi-stage control) between the storing position P1 and the extending position P2 based on a plurality of predetermined angles. In this way, the airflow guided by the diffuser device 110 may be adjusted more accurately.

Further, in the above process, the diffuser device 110 is turned on first, and after the vehicle 50 starts traveling and the information on the direction of the natural wind is obtained, it is then determined to maintain the turning-on state of the diffuser device 110 or to turn off the diffuser device 110 based on the information on the direction of the natural wind and the determination results of the angle θ relative to the natural wind and the predetermined angle. However, in other embodiments that are not shown, the diffuser device 110 may turned off first, and after the vehicle 50 starts traveling and the information on the direction of the natural wind is obtained, it is then determined to maintain the turning-off state of the diffuser device 110 or to turn on the diffuser device 110 based on the information on the direction of the natural wind and the determination results of the angle θ relative to the natural wind and the predetermined angle. In the disclosure, the specific method of controlling the moving position of the diffuser device 110 according to the direction of the natural wind is not limited, and it can be adjusted according to needs. In addition, as long as the diffuser device 110 is movable between the storing position P1 and the extending position P2, and the diffuser device 110 may also be maintained at a middle position between the storing position P1 and the extending position P2 depending on the conditions of the traveling wind or the natural wind.

In thus can be known that in the vehicle control system 100 provided by this embodiment, the diffuser device 110 may move to the storing position P1 or the extending position P2 according to the direction of the natural wind, so that the airflow guided by the diffuser device 110 may be more accurately adjusted according to the actual situation. In particular, during the traveling process of the vehicle 50, according to the direction of the natural wind and the driving requirements (for example, the setting of the predetermined angle and the predetermined period of time, etc.), the control device 130 controls the movement of the diffuser device 110 according to the direction of the natural wind detected by the natural wind detecting device 120. The predetermined angle is set for the purpose of preventing the phenomenon of the crosswind lowering the air resistance value from occurring. Therefore, even if the crosswind is strong (the angle θ is greater than the predetermined angle), it is preferable to move the diffuser device 110 to the storing position P1 (that is, the diffuser device 110 is turned off), and the aerodynamic performance of the vehicle 50 may then be further improved. In this way, the vehicle 50 can achieve optimal aerodynamic performance regardless of natural wind conditions (wind speed and wind direction). Accordingly, the vehicle control system 100 can improve the aerodynamic performance of the vehicle 50.

In view of the foregoing, in the vehicle control system provided by the disclosure, the diffuser device is configured to be movable between the storing position stored in the rear bumper and the extending position protruding from the rear bumper toward the rear of the vehicle. The natural wind detecting device detects the direction of the natural wind relative to the vehicle. The control device controls the movement of the diffuser device in response to the direction of the natural wind. Preferably, when the angle of the direction of the natural wind relative to the straight direction of the vehicle is less than the predetermined angle, the control device controls the diffuser device to move to the extending position. Further, when the angle of the direction of the natural wind relative to the straight direction of the vehicle is greater than the predetermined angle, the control device controls the diffuser device to move to the storing position. In this way, the diffuser device can move to the storing position or the extending position according to the direction of the natural wind, so that the airflow guided by the diffuser device may be more accurately adjusted according to the actual situation. Accordingly, the vehicle control system provided by the disclosure can improve the aerodynamic performance of the vehicle.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A vehicle control system, comprising:
a diffuser device installed on a rear bumper of a vehicle and configured to be movable between a storing position stored in the rear bumper and an extending position protruding from the rear bumper toward the rear of the vehicle;
a natural wind detecting device installed on the vehicle to detect a direction of the natural wind relative to the vehicle; and
a control device arranged on the vehicle and controlling movement of the diffuser device in response to the direction of the natural wind.

2. The vehicle control system according to claim 1, wherein
the natural wind detecting device detects an angle of the direction of the natural wind relative to a straight direction of the vehicle.

3. The vehicle control system according to claim 2, wherein
the natural wind detecting device detects a pressure value of the natural wind, and
the angle of the direction of the natural wind relative to the straight direction of the vehicle is calculated by calculating the pressure value.

4. The vehicle control system according to claim 2, wherein
when the angle of the direction of the natural wind relative to the straight direction of the vehicle is less than a predetermined angle, the control device controls the diffuser device to move to the extending position, and
when the angle of the direction of the natural wind relative to the straight direction of the vehicle is greater than the predetermined angle, the control device controls the diffuser device to move to the storing position.
